(19) United States
(12) Patent Application Publication
(10) Pub. No.: US 2012/0095799 A1
(43) Pub. Date: Apr. 19, 2012

(54) System and method for facilitating continous quality improvement

(76) Inventors: Gregory Jacobson, Austin, TX (US); Matt Paliulis, Dallas, TX (US)

(21) Appl. No.: 13/200,690

(22) Filed: Sep. 27, 2011

Related U.S. Application Data
(60) Provisional application No. 61/386,775, filed on Sep. 27, 2010.

(51) Int. Cl. G06Q 10/06

(52) U.S. Cl. 705/7.15

(57) ABSTRACT

A quality improvement system and associated methods are contemplated. The quality improvement system is configured to collect and route ideas from and between users of the system. The routing of ideas may be based on a user hierarchy that is adaptable and scalable to support any organization desiring to utilize the contemplated system. The system may also be configured to assist users in evaluating and implementing collected ideas and to report on the impact of any implemented ideas. To facilitate and encourage the submission of ideas a process of challenging employees to provide ideas may also be provided. The process may be used by management to solicit ideas from employees and may be an incentive-based process.

### CLAIM OF PRIORITY

This Application claims priority to U.S. Provisional Patent Application No. 61/386,775 to common inventor Paliulis et al, dated 27 Sep. 2010 and entitled System and Method for Facilitating Continuous Quality Improvement.

### FIELD OF THE INVENTION

The present invention relates generally quality improvement and in particular to a system and a method for facilitating continuous quality improvement.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

A variety of systems and methods have been used to generate innovation and development in industry to maximize efficiency and further improve products and services. For example, sales companies started utilizing the contact between recipients and their deliverers in order to develop more sales. In essence, the employee who delivered the product was authorized to make further sales. This idea was originally developed by a delivery truck driver who had been asked by customers for more products. The idea was developed and delivered to management. After consideration, the idea was approved by management for implementation.

Currently there are a number of solutions such as electronic suggestions boxes, or idea management systems for collecting and implementing ideas in an organization. However, such systems are focused on identifying and implementing a small number of complex ideas and fail to provide an efficient means for identifying and implementing numerous low complexity, low cost, or low risk ideas. Known solutions provide users with tools to schedule massive projects and allocate and track resources across an organization. However, these solutions fail to meet the needs of the industry because they are inefficient and costly for facilitating the collection, implementation and analysis of such low complexity, low cost, or low risk ideas. In particular, known solutions fail to facilitate continuous quality improvement as is encouraged by the Kaizen philosophy. The Kaizen philosophy encourages teamwork, personal discipline, improved morale, quality circles, and suggestions for improvement, for the purpose of improving all functions and processes in an organization. Known solutions are also difficult and costly to implement in an organization.

Other known solutions that address continuous quality improvement include: grass roots efforts started by a small group of people, hiring temporary consultants, and establishing stand-alone quality departments within an organization. While these methods can produce results, there are serious obstacles to success. Grass roots efforts lack the structure and management support needed to be a viable option in the long run. Consultants provide results during their tenure, but are expensive and often fail to engage the whole organization to make continuous quality improvement every employee's job. Stand-alone quality departments are also expensive to maintain and often fail to make continuous quality improvement every employee's job.

It would be desirable to have a system and method for facilitating continuous quality improvement that can be used to collect and encourage the submission of low complexity, low cost or low risk ideas in an efficient manner. Furthermore, it would also be desirable to have a system and method for facilitating continuous quality improvement that can be used to facilitate the implementation of collected ideas. It would further be desirable to have a system and method for facilitating continuous quality improvement that provides improved product or process quality, saves costs, provides improved customer and employee satisfaction and decreases process errors. It would also be desirable to have a continuous quality improvement system that is easier and less costly to implement in an organization than known solutions. It would further be desirable to have a system and method for encouraging employees to think critically about their job, identify areas for improvement, and to provide an environment where employees can connect and collaborate with employees in other departments in the organization. Therefore, there currently exists a need in the industry for an improved system and method for facilitating continuous quality improvement in an organization.

### SUMMARY OF THE INVENTION

The present invention advantageously fills the aforementioned deficiencies by providing a system and method for facilitating continuous quality improvement in an organization that does not suffer from the problems or deficiencies associated with prior solutions.

The contemplated system provides a quality improvement server adapted to communicate with a plurality of client devices. The quality improvement server includes program modules for handling collection and routing of ideas, also known as Opportunities for Improvement (OIs), from and between users of the system. The routing of ideas may be based on a user hierarchy that is adaptable and scalable to support any organization desiring to utilize the contemplated system. The user hierarchy is associated with a rules-based engine that is configurable based on arrangement of users in the user hierarchy. The user hierarchy may also be configured to support setting of permissions that are used to determine who can perform various actions on the ideas collected by the system. The program modules may also be configured to assist users in evaluating and implementing collected ideas and to report on the impact (e.g. time savings and economic) of any implemented ideas. To facilitate and encourage the submission of ideas a process of challenging employees to provide ideas may also be provided. The challenge process may be used by management to solicit ideas from employees and may be an incentive-based process. The program modules may also be configured to allow users to create custom lists of ideas for monitoring and research purposes. They may also support a check list feature for allowing users to break ideas into smaller sub tasks and to assign and track those subtasks to specific individuals. The program modules may also support reporting capabilities for generating metrics and analytics on idea submission and implementation by users or departments. A flagging feature may also be provided for allowing the creation of personalized dashboards for each user informing them of the progress of ideas related to them in some way.

The contemplated system may also provide an incident reporting system. The system may also allow non-employees such as customers or patients (when utilized in a health care organization) to submit ideas for improvement.

As discussed, the program modules may be configured to route ideas, govern permissions and disseminate information based on the configurable user hierarchy. Once an idea is entered into the system, the idea is routed based on the user hierarchy to the appropriate users. The user hierarchy not only governs the flow of ideas, but enables employees to assign ideas to people below them in the hierarchy, effectively distributing control over the implementation of these ideas to a grassroots level. The user hierarchy may be created and modified by an administrator of the system by way of a graphical interface that displays the hierarchy as an organizational chart. The administrator may use the graphical interface to define graphical nodes representative of a department, work group or sub work group. Users may then be associated with a node. The hierarchy of nodes governs permissions and determines the flow of information through the system. Reconfiguring the hierarchy (e.g. by dragging and dropping users via the graphical interface) causes all of the associated business rules that govern permissions, routing of ideas and information dissemination to update automatically.

The program modules may also support a flagging feature for providing notifications to stakeholders when progress is made or a predetermined time has passed where no progress has been made by a user on a particular OI or Challenge. The setting of flags may also be governed by the rules-engine associated with the user hierarchy and may be user and OI or Challenge specific (e.g. a single OI can be flagged for a particular individual and that individual only).

Among other things, it is an object of the present invention to provide a system and method for facilitating continuous quality improvement that does not suffer from the problems or deficiencies associated with prior solutions.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

Various aspects of the invention, as well as an embodiment, are better understood by reference to the following detailed description. The detailed description, given by way of examples and not intended to limit the present invention solely thereto, will be better understood when read in conjunction with the drawings wherein like reference numerals denote like elements and parts in which:

FIG. 1 is an overview of the system for routing opportunity of improvement ideas.

FIG. 2 is an example of the breakdown of an organization developed hierarchy.

FIG. 3 is the view of the process of the receipt of the organization hierarchy, the idea, and routing said idea.

FIG. 4 is the view of the process of routing the opportunity for improvement idea with the addition of an assignment step.

FIG. 5 is a view of the steps of the completion receipt of idea implementation and notification.

FIG. 6 is the process of the addition of the challenge function in the system.

FIG. 7 is the view of the user applet for monitoring the routing process.

FIG. 8 is the process of receipt of opportunity for improvement idea, routing of said idea, and receipt of completion of said idea.

### DESCRIPTION OF A BEST MODE

### Interpretation Considerations

When reading this section (an exemplary embodiment of a best mode, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for —functioning—” in the Claims section. Sixth, the invention is also described in view of the Festo decisions, and, in that regard, the claims and the invention incorporate equivalents known, foreseeable, and unforeseeable. Seventh, the language and each word used in the invention should be given the ordinary interpretation of the language and the word, unless indicated otherwise.

Some methods of the invention may be practiced by placing the invention on a computer-readable medium. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Unless otherwise indicated, acronyms used have the ordinary meaning of those acronyms in the context presented, and are readily understood by those of ordinary skill in the art. Words and phrases are to be given their ordinary plain meaning unless indicated otherwise. The present invention is directed to a system and method for facilitating continuous quality improvement in an organization.

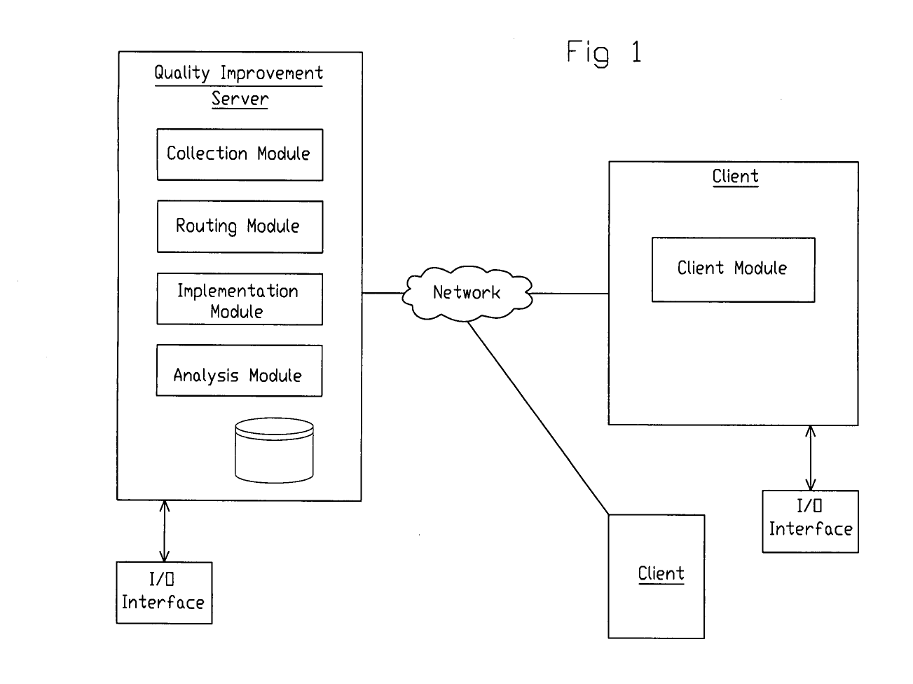

Referring to FIG. 1, a block diagram is shown illustrating 1 a quality improvement system in accordance with an exemplary embodiment of the invention. The quality improvement system may include a server adapted to be communicatively coupled to a plurality of client devices by way of a network such as the Internet. The quality improvement server may be a single computing device having a processor and memory or may include multiple computers communicatively coupled into a distributed cloud-based architecture. The quality improvement server includes program modules containing executable instructions for handling operation of the server. The program modules include a collection module for handling solicitation and receipt of submitted improvement ideas from the client devices. The quality improvement server also includes a routing module for routing improvement ideas between users of the system. The quality improvement server may also include an implementation module for searching submitted ideas and for assigning and tracking the implementation of submitted ideas. The quality improvement server may also include an analysis module for determining the effects of previously implemented ideas. The quality improvement server may also have a data repository for storing user information, submitted ideas, hierarchy data as well as information related to the tracking of submitted ideas. The quality improvement system further comprises a plurality of client devices, each of which includes a client module and a user Input/Output (I/O) interface. By way of example, each client device may be a computing device having a processor and memory such as a personal computer, a phone, a mobile phone, or a personal digital assistant. The client I/O interface may include a keyboard, mouse, monitor, touch screen or similar interface device suitable for allowing a user to interact with the client device. 1 The client module is responsible for handling communication with the quality improvement server (e.g. submitting received ideas, receiving suggested ideas, receiving implementation information and configuring the user hierarchy) and for providing a user interface to a user of the client device.

The rules for an opportunity for improvement idea are guidelines to improve functionality of the system. Generally speaking, when an OI (idea) is submitted, every leader (group or department leader) above the idea originator (Author) in the hierarchy is notified. These people are notified by email, a summarized email digest, and a flagging feature that marks the OI within the system. Because of their position in the hierarchy and their relationship with the OI, the leaders can assign the idea to anyone below them in the Network. Certain leaders can transfer the OI to other departments.

After a successful login, a User can enter an OI. Once the OI has been entered, all the Leaders directly above the User in the hierarchy will be notified. These leaders are known as node leaders. Any Node Leader who was notified can decide to assign any User below themselves in the hierarchy to work on the OI. The User who assigns the OI will be referred to as the Assigned By. The User who has been assigned to work on the OI will be referred to as the Responsible Assignee (RA). The RA will be responsible for completing the OI.

The RA will have a feature called the Check List where they will be able to define actions that need to be taken in order to complete the OI. These actions will be referred to as Check List Items. The RA will have the ability to assign Check List Items to themselves or to any User below them in the Hierarchy. They will also have the ability to request Users who are not below them in the Hierarchy to work on a Check List Item. A User who is responsible for a Check List Item will be referred to as the Accountable Assignee (AA).

As the RA and AAs work to implement the OI, the Update Thread will automatically log the progress made on the OI. The Update Thread is data description maintained and saved in the network by the system to retain notes regarding the development of the OI. Depending on the nature of the update, the appropriate Users who are related to the OI will be notified as part of the idea notification group.

User notifications will be in the form of emails as well as Flags. The Flags will be OI and User specific. This means that for every OI a User can have single or multiple Flags identify certain bits of information for specific Users. Each Flag will have a Flag Code that will provide a description of the Flag as well as a color indicating its importance level. For example, if a Check List Item is within five days of being overdue, the OI will be flagged with that information for the RA and the AA of the Check List Item.

Once the RA deems that the OI has been completed, they will submit a Resolution to the Assigned By. During the process of submitting the Resolution, an Outcome Classification will need to be selected. If the Outcome Classification is that a Process Improvement occurred, then a Type will need to be selected as well. Each Type has its own set of specific questions. Once the Assigned By is satisfied with the Resolution, the Resolution will be accepted and the OI will be completed.

The system has numerous features designed to get the idea implemented. First, ideas are assigned to individuals to complete with a due date. The system automatically holds them accountable by keeping responsible parties in that idea notified about the progress. This is accomplished primarily by two methods; 1) by using a flagging feature on the responsible parties' personalized dashboards within the network and system and 2) by an email alert feature that reaches out to notify the responsible parties. In addition, the system can also employ a check list (discussed in detail later) feature that allows components of the idea to be assigned to individuals with due dates. Just as above, the system keeps the responsible parties and intended recipients informed via flags and email alerts.

In the system, once ideas are implemented, they are categorized and estimates are put on how much time or money was saved because of this idea. The idea is then stored in the database for others to reference in the future. Metrics and reports can be run on the number of ideas implemented as well as their associated savings etc. Individuals, groups, or departments can be evaluated based on how effectively and efficiently they solicit, evaluate, and implement ideas.

In the network, ideas are also routed via a hierarchy via the system. This system is different for the following reasons: all staff members are included, the hierarchy can be modeled on how an organization actually works, the hierarchy does not limit the flow of ideas base on a score or rating, rather it insures that each idea is routed to everyone above the submitter in the hierarchy, and the hierarchy governs the permissions of what actions a specific user can perform on a specific idea base on their relative position to the submitter of that idea in the hierarchy.

All users for a given instance are organized in a parent-child hierarchy, referred to as the hierarchy. It is graphically represented and can be accessed by all users in view-only mode. It can be accessed in edit mode by department and organization administrators as predetermined by the hierarchy within the network. Each OI will have its own separate network. A user's position in the hierarchy governs what they can view and what actions they can perform. For example, once a user creates and submits an OI, rules based on the hierarchy determine the users who can assign it to be worked on. If their position changes in the hierarchy, so does the content that they can view and assign. The hierarchy is organized into departments, which are in turn organized into work groups. The departments and work groups are sometimes referred to as nodes. For example a hospital's departments are intended to represent a major area of operations such as Emergency Medicine, Cardiology, or Pediatrics. Work groups are intended to be logical groupings of Users within the department such as nurses, doctors, and administration. These work groups do not have to strictly follow along the traditional organization structure of the health care organization, although we predict they will. They are rather to be used to organize the department according to its Continuous Quality Improvement (CQI) efforts. For example, while there may be three “managers” below a department leader, for the purposes of the department's CQI efforts, it may be determined that the best approach would be to have only one of the managers be the leader of the work group within the hierarchy and for the other two managers to be users in the work group.

In addition to departments and work groups there also exists the possibility of further organizing work groups into additional work groups beneath them in the hierarchy. This is intended to provide the flexibility needed to customize the hierarchy to more closely match the organization structure of a health care organization. Each individual user will belong to a node as either the leader of that node or as a member of that node. In some examples, an individual can only exist in one place in the hierarchy. In other examples, the user can exist in multiple places within the hierarchy. Users can belong directly to any node in the hierarchy, regardless if the node also has work groups beneath it. Each of the nodes in the hierarchy must be assigned a leader. The leader will be the ‘parent’ for all those users directly below them the hierarchy. All submitted OIs will ultimately flow up to the node leaders directly above the author of the OI. Node leaders can be changed at any time.

It is not possible for a single User to be assigned as the Leader of multiple unrelated nodes. However, a node leader can assume the leadership responsibilities of multiple nodes (departments/work groups) beneath them in the hierarchy if the leader of the node below the node they are leading is removed. For example, if the leader of a work group beneath a department node is removed and the hierarchy is saved in the network without a leader being replaced, this work group will be led by the department leader. This will be referred to as an inherited leader. In the graphical depiction (to be described below), the department leader will appear as the leader for both nodes (department and the work group).

In addition to the typical users in the network, there also exist three other types of users, deputy leader organization admins and department admins. A network leader can fall anywhere in the hierarchy, but will have the equivalent authority to modify and assign OIs as their department leader does. The purpose for this it to allow a department leader to remain in a position of authority while at the same time, deputize an individual to take an active role in promoting and driving the CQI efforts within the department. This “super user” exists to create flexibly to the hierarchy to allow it to more accurately model the inter workings of a department in an organization. It is thought that there will only be a few deputy leaders per department.

There can be organization and department administrators, referred to as organization admins. The organization admins will be the administrators of their instance and will be charged with maintaining the hierarchy and the system in the network and managing the organization logos, web links, employment status, and titles. An organization admin can fall anywhere in the hierarchy, system, and network. They will also appear in the admin list. The department admins will be the administrators of their department and will be in charge of maintaining their section of the hierarchy, system, and network and managing department categories, priorities, positions and web links.

The metricizing of the hierarchy includes four main aspects to the development of a hierarchy within an organization. These are increasing the scope of the hierarchy, allowing users to exist in multiple locations, allowing work groups to have multiple leaders, and metricizing the hierarchy further.

Increasing the scope of the Hierarchy allows the organization to add levels to the hierarchy including geographic levels, locational levels, and development levels. The top level of the hierarchy is the instance. The instance is divided into departments which are divided into work groups. The hierarchy can add level(s) above the current “highest” level. This allows the system to adapt to more complex organizations. For example, in the health care industry the system could map a hospital system that has multiple hospitals that have multiple departments etc. In order to adapt the system for different industries, the additional levels can be customized. This adds to the ability of the system to be able to adapt to other industries better (Company/Division/Departments/Work Group etc. or Conglomerate/Company/Department/Work Group etc). Leaders in the executive department, department leaders and deputy leaders have permissions that allow them to transfer OI into other hospitals, collaborate on system, network, and department challenges with other hospitals, and view data in other hospitals.

Allowing users to exist in multiple locations in one instance is a feature for more complex organizations where a user has multiple roles within the organization. Users are able to exist in multiple instances (multiple hospitals). Sometimes individuals hold positions at different hospitals or different health care entities within a geographically similar area. These individuals would need to be able to enter ideas in either health care entity (ex: hospital and nursing home) and have the idea routed according to their position in the respective instance. The user has to choose which instance he is addressing when he logs into the system each time. All other rules and permissions would stay the same for them within that Instance and would not affect the other instance.

The network allows work groups to have multiple leaders. Work groups (not departments) have the ability to have multiple leaders. From a rules perspective, this means that multiple people have the permissions to assign OIs that were submitted from people below them in the hierarchy.

User permissions within the system reflect the user's multiple locations. For example, if a user was the work group leader of group A and also existed as a regular user in department G, the user would be able to assign OIs submitted from below them in work group A, but only to people in work group A. The user would not have the ability to assign OIs submitted in department G or the ability to assign OIs to people in department G. When that user submitted an OI, the user would be able to select which people (superiors in A, superiors in G, or both) would receive notification about their OI.

The hierarchy is created through a set of rules to govern its development. The hierarchy's basic function will be to determine the routing of ideas (OIs) and notifications as well as defining user privileges. Each organization will be divided into departments. Each Department will be subdivided into nodes. Nodes can be further subdivided into additional nodes, creating a more in-depth hierarchical structure. Every user must be placed either directly into a Department or in a node. Every department and node has a Leader.

When a user submits an idea, the leader of the node they belong to as well as the leader of each node directly above the user's node will be notified. In other words, the user's boss, their boss's boss, their boss's boss's boss etc. will be notified about this idea. These leaders are part of the idea notification group. In the event that a re-organization of the company happens and the structure of the company changes, so too will the hierarchy. The rules of who is notified will be dependent on the structure of the configurable hierarchy.

In addition to the routing of the ideas, permissions can also be regulated. For example, the system can restrict assignment capabilities to only a node leader or a department leader. Second, a leader can only assign people below them in the hierarchy to work on an OI. In the event that a reorganization of the company happens and the structure of the company changes, the user permissions can also be altered to reflect those changes. The rules of which persons who can assign ideas can be restricted to being dependent on the structure of the configurable hierarchy. Certain special permissions can be created such as only department leaders can transfer ideas from one department to another. Department leaders are also the only ones who can issue challenges to their department to come up with ideas on a certain topic.

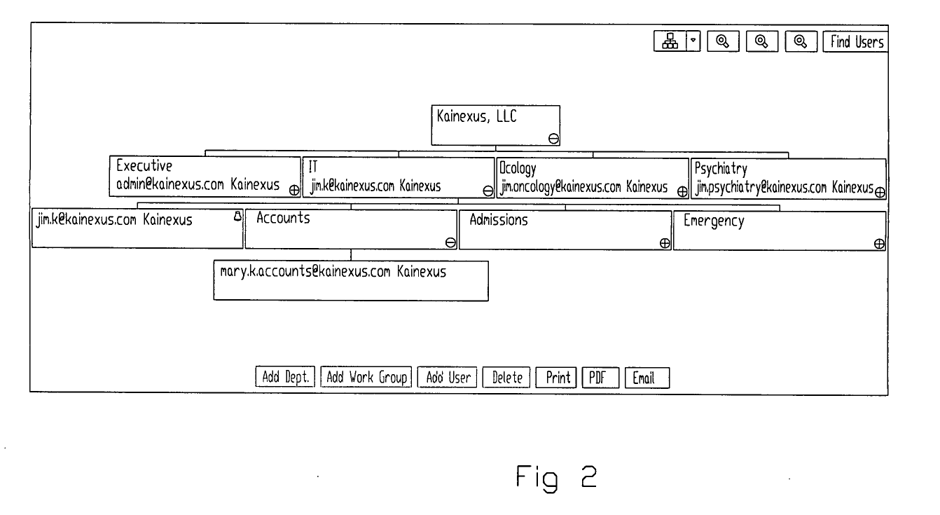

Referring to FIG. 2, a diagram is shown illustrating an exemplary graphical hierarchy that can be used with the exemplary system of FIG. 1. Each user in the system is placed within the hierarchy relative to other users. All Users for a given instance of the system are organized in a parent-child hierarchy graphically represented as an org chart. All users may view the org chart. Changes can be made to the hierarchy, by users such as department or organization administrators with sufficient permissions. The hierarchy is used to govern who can view certain elements and who can perform certain actions. For example, when a user creates and submits an OI, rules based on the hierarchy determine which users can assign it to be implemented. The hierarchy may be organized into departments, which are in turn organized into work groups, followed by sub work groups. Departments, work groups and sub-work groups are also referred to as nodes. Departments are intended to represent a major area of an organization's operations such as emergency medicine, cardiology, or pediatrics. Work groups are intended to be logical groupings of users within the department such as nurses, doctors, and administration. These work groups do not have to strictly follow along the traditional organization structure of the organization. They are rather to be used to organize the department according to its CQI efforts. For example, while there may be three “managers” below a department leader, for the purposes of the 1 department's CQI efforts, it may be determined that the best approach is to have only one of the managers be the leader of the work group within the hierarchy and for the other two managers to be users in the work group.

In addition to departments, work groups, and sub work groups, there also exists the possibility of further organizing sub work groups into additional sub work groups beneath them in the hierarchy. Therefore there can be sub, sub-work groups etc. This is intended to provide flexibility needed to customize the hierarchy to more closely match the organizational structure of any organization that desires to use the system.

In addition to the regular departments, there may also be a predefined non-deletable department called the executive department. This department contains the executive tier of an organization. The executive department may have a user designated as the leader of the executive department.

While the executive department is non-deletable, its use is optional as the hierarchy is designed to function without users being in the executive department. If an organization chooses not to use this department, they would simply not add any users to it. The executive department leader is able to modify OIs in all departments. This global authority will be useful for those executives who want the ability to take an active role in the CQI efforts throughout the entire organization, but do not want to have any day-to-day responsibilities outside of the executive department.

Each individual user belongs to a node. Each user may be designated as either the leader of that node or as a member of that node. Users can belong directly to any node in the hierarchy, regardless of whether the node also has work groups or sub work groups beneath it. The administrator may add, view and modify users associated with nodes via the user interface shown in FIG. 2. As shown, the user may view the member of a node by clicking on the plus/minus sign within a node. As shown, the exemplary accounts node has been expanded in this manner and includes one member.

Each of the nodes in the hierarchy may be assigned a leader. The leader is the ‘parent’ for all those users directly below them the hierarchy. All submitted OIs ultimately flow up to the node leaders directly above the author of the OI. Node leaders can be changed at any time.

A node leader can assume the leadership responsibilities of multiple nodes (Departments/Work Groups/Sub-Work Groups) beneath them in the hierarchy if the leader of the node below the node they are leading is removed. For example, if the leader of a work group beneath a department node is removed and the hierarchy is saved without a leader being replaced, this work group will be led by the department leader. This is referred to as an inherited leader.

In addition to the typical users in the hierarchy, other types of users may be added including: deputy leaders, organization administrators and department administrators. A deputy leader can fall anywhere in the hierarchy, but will have the equivalent authority to modify and assign OIs as their department leader does. The purpose for this it to allow a department leader to remain in a position of authority while at the same time, deputize an individual to take an active role in promoting and driving the CQI efforts within the department. The deputy leader exists to create flexibly to the hierarchy to allow it to more accurately model the inner workings of a department in an organization. Within the executive department, there may be executive deputy leaders. These leaders will be similar to deputy leaders in their respective departments, as they will have the same authority as the executive department leader. The organization administrators are the administrators of the system instance and will be charged with maintaining the hierarchy and managing the organization's settings such as logos, links, and titles. An organizational administrator can fall anywhere in the hierarchy. They also appear in an administration list.

The department administrators will be the administrators of their department and will be in charge of maintaining their section of the hierarchy and managing department categories, priorities, positions and web links. The administrators may use the graphical interface to define graphical nodes representative of a department, work group or sub work group. Users may then be associated with a node. As discussed, the hierarchy of nodes determines the flow of information through the system.

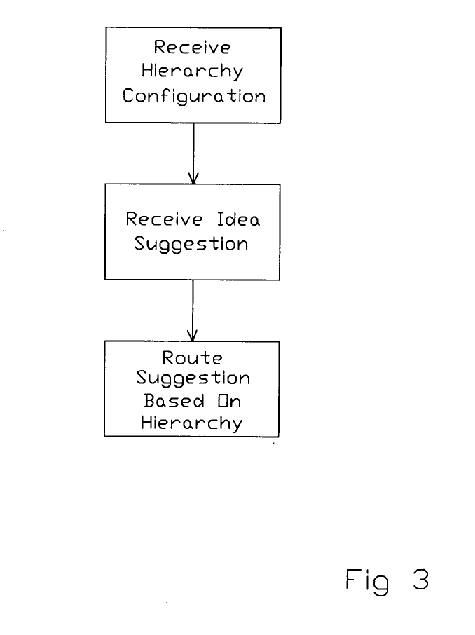

Referring now to FIG. 3, a flow diagram is shown illustrating an exemplary process that can be carried out in accordance with the contemplated quality improvement system. As shown, the process commences at a first step when an administrator of the system configures the hierarchy of the organization implementing the system. As discussed, each user may be associated with a node and connected to one or more users that are positioned above or below them in the hierarchy. The user hierarchy controls the routing of received ideas. By way of example, ideas entered into the system at one of the client devices may be referred to as Opportunities for Improvement Idea (OIs). Once an OI is entered into the system (e.g. at one of the client devices), the OI is transmitted to the quality improvement server. At a next step, the collection module receives, archives and processes the OI. The routing module subsequently routes the received OI to one or more users (located e.g. at one of the client devices) based on the customizable user hierarchy. By way of example, ideas may be routed to all users positioned above the user as defined by a rules engine associated with the customized user hierarchy. Each user who has received the idea may then evaluate the idea for possible implementation.

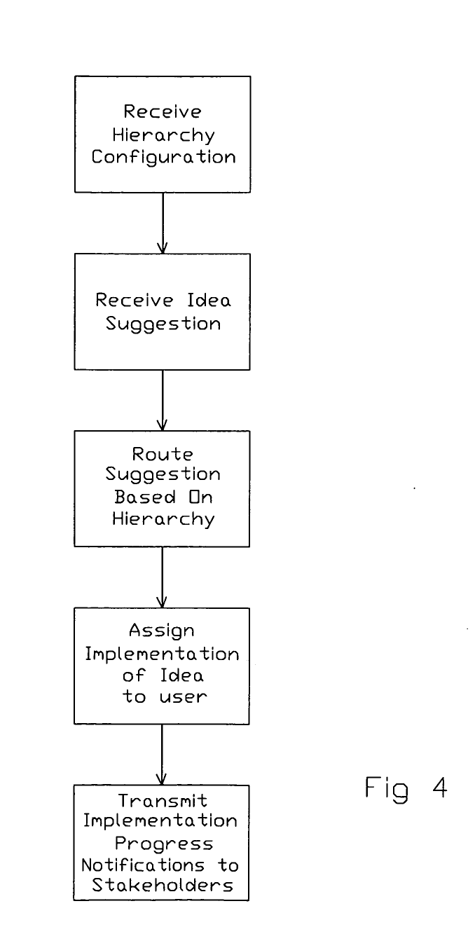

Referring now to FIG. 4, a flow diagram is shown illustrating another exemplary process that may be carried out in accordance with the contemplated quality improvement system. The process shown in FIG. 4 proceeds in a manner similar to that shown in FIG. 3. However, the process of FIG. 4 also includes steps for facilitating implementation of the OI. An OI may first be assigned to a user for implementation by another user, such as a node leader, having the authority to make such assignments. Such assignments are governed by the rules-based engine which is configurable based on the user's position in the user hierarchy. The assignment may also include a due date. A check list feature may also be provided to allow the idea to be broken into sub-tasks and assigned to different users with associated due dates. After the implementation module receives and processes the assignment information the routing module may then route the assignment to the user or users to whom the task of implementing the idea is assigned to. It is noted that when the OI is broken into subtasks, the assignment of each sub-task is also governed by the same rules-based engine as is used to assign OIs. The implementation module automatically holds the implementer accountable by keeping stakeholders (e.g. the user performing the assignment and the user who submitted the idea, also known as responsible party) in that OI notified of any implementation progress. This can be accomplished by providing a flagging feature on a stakeholder's personalized dashboard and/or by providing email alert notifications to the stakeholders when progress is made or a predetermined time has passed where no progress has occurred. The setting of flags may also be governed by the user hierarchy and may be user and OI or Challenge specific (e.g. a single OI can be flagged for a particular individual and that individual only). By way of example, if a predetermined time has passed where no progress has been made on a particular OI, the OI is flagged with a specific message for the individual responsible for it. In addition, other users that the rules-based engine has determined (based on the customizable user hierarchy) should know that the OI is overdue will also receive the message. These flags may be presented to the user via their personalized dashboard. The process may also include a step of searching an archive of unimplemented ideas by potential implementing users or users responsible for assigning OIs for implementation. The process may also include a step of searching user profiles to determine who the most appropriate people are to implement/evaluate unimplemented ideas.

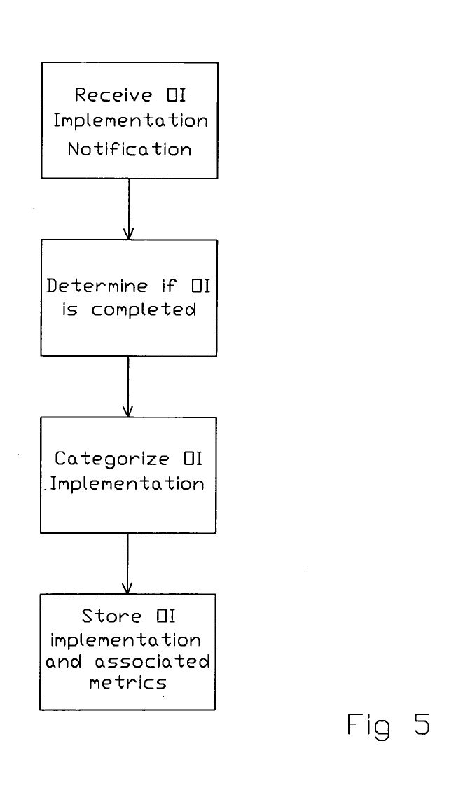

Referring now to FIG. 5 a flow diagram is shown illustrating another exemplary process that may be carried out in accordance with the contemplated quality improvement system. The process shown in FIG. 5 proceeds in a similar manner to that shown in FIG. 4. However, the process of FIG. 5 also includes steps related to post-implementation analysis. After implementation of an idea is completed, a resolution process may be performed by a user responsible for the assignment of the OI. The resolution process may include responding to a set of questions that are provided by the analysis module via a resolution interface window. The resolution can progress through a series of statuses. An OI is given the status of completed once it has a resolution with a status of accepted. In order to complete an OI, the user that assigns or is otherwise responsible for the OI goes through a resolution process that consists of filling out a series of resolution questions about the result of the OI. The process begins with the user having to enter text that describes the outcome of the OI, confirming a category of the OI, and assigning an outcome classification. By way of example the category may be selected from one of: a process improvement, information dissemination about a current CQI effort, information dissemination about a department's/organization's current standard operating procedure (SOP), no operational change because the process was out of the department/organization's control and no operational change was deemed necessary. If the outcome classification is a process improvement then the user is also prompted to select a type (or types) of improvement. The process improvement type may be selected from one or more of: error correction or prevention, cost savings, time savings, customer satisfaction, employee satisfaction and quality improvement. Each selected process improvement may then cause the system to request additional information from the user for describing the type of process improvement. By way of example the following types of additional information may be requested (note that this questionnaire relates to a healthcare organization and is for illustrative purposes only): Process improvement type: error identification, correction, or prevention

Has this error 1 been made before?

### 1) Y/N

If yes go to question #2.
If no go to question #6.
2) How would you classify this error?
_minor (inconvenience/delay)
_moderate (adverse outcome, medication error, x-ray wrong limb)
_significant (wrong surgery/error resulting in death)
go to question #3
3) How often do believe this error has happened in the last year?

### _# per Hour

_# per day
_# per week
_# per month
_# per year
_unknown
(can only choose one)
go to question #4
4) How often do you believe this error will be avoided in the next year as a result of this OI?

### _# per Hour

_# per day
_# per week
_# per month
_# per year
(can only choose one)
(done)
5) If this error were to occur how would you classify the potential result?
_minor (1 inconvenience/delay)
_moderate (adverse outcome, medication error, x-ray wrong limb)
significant (wrong surgery/error resulting in death)
go to question #6
6) Has this OI decreased the risk of this error happening?

If Yes, go to question #7, if No then the questions for this type of OI are completed. Yet, the User will be ask a verify step which will state—Are you sure you want to complete an OI that has identified a error yet not decreased the chance of this error happening in the future?

Ok=removes verify step
7) How often you think this error will be avoided as a result of this OI in the next year?

### _# per Hour

_# per day
_# per week
_# per month
_# per year
(can only choose one)
(done)
Process Improvement type: cost savings
1) How much savings do you think this OI has saved the department/organization?
_$ per day
_$ per week
_$ per month
_$ per year
2) How did you base the above calculation?
Free text:______
Process Improvement type: time savings
1) Whose time are you saving? You may pick multiple types of people.
_patient

### _Administrator

### _Patient Tech

### _Paramedic

### _RN

### _MD

### _Maintenance Staff

### _Environmental 1 Service Staff

### _Nutritional Services Worker

### _Radiology Tech (IR, Ultrasounds, X-ray, CT Scan)

### _Orderly

### _Transporter

### _Registration

### _Billing

_etc.
When User clicks on check box of a specific person type, then the following question may also appear to the right of the type of person identified.
1)_time unit saved (sec/min/hrs) x_# of events per (hr/day/wk/yr)
User will need to select second, minute, or hour and hr, day, week, or year.
2) How did you base the above calculation?
Free text:______
Process Improvement type: patient satisfaction
1) Do you think this has resulted in a change that patients would consider small (better coffee), moderate (decrease cost/wait times), or large (improve outcome/care) in nature?
_small
_moderate
_large
2) This OI relates to:
_quality of care
_wait times
_diagnosis
_symptom reduction
_accessibility to care
_communication with patient
_cost to patient
_billing error
_other
_enter other:______
Process Improvement type: employee satisfaction
1) Do you think this has resulted in a change that employees would consider to be small (better coffee), average (improved work environment), or large (increased pay)?

### _Small

_moderate
_large
2) Do you think this OI result could lead to increased retention?

### Y/N

Process Improvement type: quality improvement
1) Do you think this OI has resulted in a quality improvement that would be considered to be small (improved bandading material), average (quicker diagnosis or pain medication administration), or large (more accurate diagnosis or improved outcome)?

### _Small

_moderate
_large

If a user who is responsible for the OI fills out the resolution, then the resolution needs to be reviewed and approved by the user who assigns the OI before the OI's status changes to completed. If the user that assigns the OI fills out the resolution, there is no approval process and the status of the OI is set to completed. The idea can then be stored in the data repository for other users to reference in the future. Individuals, groups, or departments may also be evaluated based on how 1 effectively and efficiently they solicit, evaluate, and implement ideas.

Once these metrics are recorded and the resolution is accepted by the person who assigned to idea to the responsible person, they are saved in the database. At that point, reports can be run that aggregate the metrics by ideas submitted by a person, within a node, within a department, or a whole organization. One possible report would be to show the total time saved in minutes from ideas resolved during the year. Another possibility would be what percentage of ideas submitted in the department resulted in a staff satisfaction action that lead to increased retention.

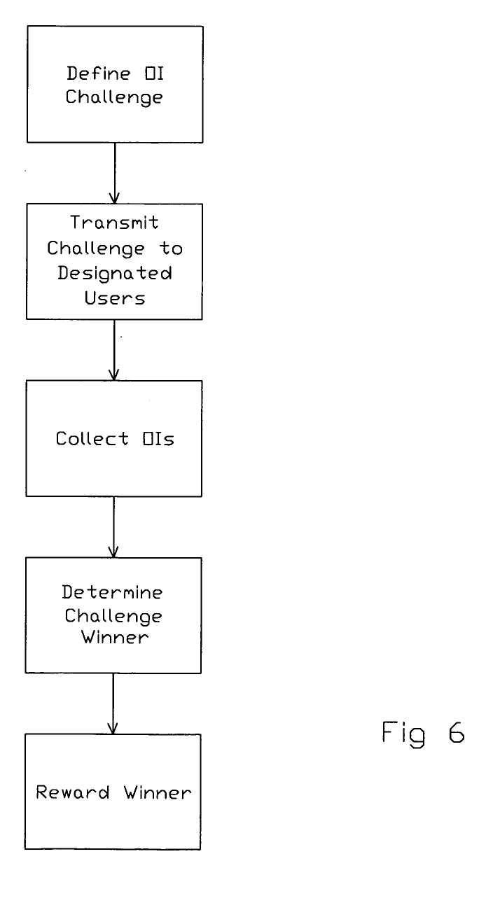

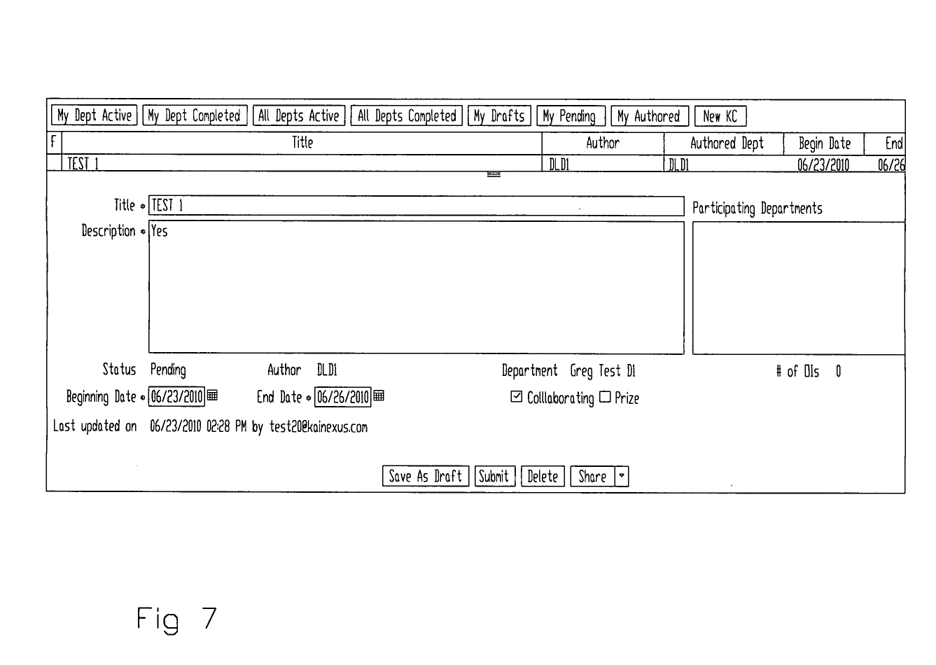

Referring now to FIG. 6, a flow diagram is shown illustrating another exemplary process that may be carried out in accordance with the contemplated quality improvement system. The process shown in FIG. 6 proceeds in a similar manner to that shown in FIG. 3. However, the process of FIG. 6 also includes steps for allowing leaders of an organization to solicit OIs from other members of the organization by way of a formal challenge process. FIG. 7 will also be referred to which shows an interface diagram illustrating an interface that may be used to create a challenge in accordance with the process of FIG. 6. The collection module may also be configured to generate the interface window shown in FIG. 7 and to manage challenges. These challenges provide a tool for the leadership of an organization to generate OIs about a certain topic. Department leaders, deputy leaders, the executive department leader and executive deputy leaders may initiate such a challenge. Department leaders and deputy department leaders can only be permitted to create a challenge for their own department. The executive department leader and executive deputy leaders have the ability to create a challenge for any individual department, group of departments, or the entire organization.

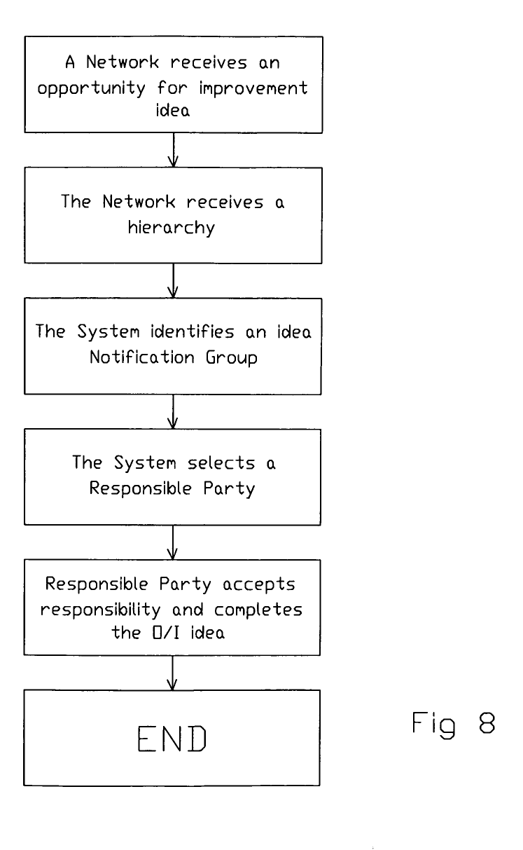

In FIG. 8, the network receives the opportunity for improvement (OI) idea. The idea can be submitted via a computer, a tablet, a disk, a hard drive, a smart phone, and/or jump drive. The idea originator includes a description of the idea. The description can include a title, a brief description of the idea, how to implement the idea, how much the idea can save financially, and additional information that assists the network's assignment and hierarchy data. The network receives a generated hierarchy. The hierarchy can be submitted prior to any idea and can be updated anytime through the network. Step 3 is the system identifies an idea notification group. The idea notification group are members of the hierarchy who receive notification of the OI submission and any updates that address the OI. Members of the idea notification group are the user who submitted the OI (the idea originator), department leaders above the idea originator, any additional responsible parties assigned by hierarchy, the idea originator or added by the first responsible parties. The responsible party is selected by one or many of the idea notification group. The OI is sent through the network by the system to the members of the idea notification group. The responsible party is the member or members of the idea notification group beyond the idea originator. The notification is submitted via the network via email, text message, daily update, or via a message when the responsible party logs into the system. The emails can be sent via a daily update, weekly, monthly, calendar update, or any other timeline pre-selected by the user or responsible party. The responsible party completes the OI and implements it. The completion can occur via a deletion and rejection of the OI, or a implementation of the OI, or in the alternative, a reassignment of the OI. When completed, the system records the data including time and financial impact of the OI.

A department leader may also have the ability to add their department to an existing challenge created in another department if the challenge is set to be “Collaborating.” A collaborating challenge is one that has been created and specifically set up so that other departments can participate in the challenge if they choose. These departments will be referred to as participating departments. A non-collaborating challenge is one where the challenge author does not want any other department to participate in the challenge. The executive leader or executive deputy leaders may author a challenge for multiple departments and set the challenge to non-collaborating. This prevents any other departments from joining the challenge other than the ones selected by the executive leader or executive deputy leader.

The challenge can remain active for a period of time pre-set by the challenge author(s) when he (they) creates the challenge. The challenge will be closed to further OI submissions once this time has passed. Once the challenge is closed to new OI submissions, the author of the challenge may pick a challenge winner. The challenge winner may also be determined by automated means, e.g. based on the metrics collected during the post-implementation analysis process. The creator of a challenge may also incentivize participation in the challenge by selecting to provide a prize that will be provided to the winner of the challenge.

OIs can be associated with a challenge when the OI is being created. The association that an OI has with a challenge is displayed when a user is viewing the OI in an OI user interface panel. Conversely, if a user wants to look at all the OIs associated with a specific challenge, then they will view this from a challenge user interface tab.

The challenge leaders or the department leader can also have the ability to “correct” the challenge association, remove it, or add it as per the rules found in the OI user interface panel. If the executive department leader or an executive leader authors the challenge, then he or she will have the ability to “correct” the challenge association, remove it, or add it.

The quality improvement server can be configured to allow users to create custom lists of ideas for monitoring and research purposes. The quality improvement server supports reporting capabilities for generating metrics and analytics on idea submission and implementation by users or departments. Specifically, the quality improvement server stores all ideas that have been implemented as well as their respective resolutions. The resolutions contains empirical data about the financial, time saving, error reduction, and employee and patient satisfaction effects of the idea being implemented. Fixed and customizable reports that allow users to report and aggregate any data entered into the system may also be provided. These reports include time and cost savings by department, work group, or individual. They also include a variety of individual and group performance reports focusing on metrics such as the length of time before an OI was assigned or the length of time it took to implement an OI.

The quality improvement server may also include a message distributing module, an education module, a calendaring module that integrates with existing products such as MS Outlook and other productivity tools such as mobile devices, a SOP (standard operating procedure) module, and a strategic initiative planning module where ideas that are more complex in nature are evaluated.

It is noted that a drawing appendix has also been included which illustrates detailed flow charts and state transition diagrams relating to the OI processing, Check list processing, OI resolution processing and Challenge processing.

The various illustrative program modules and steps described in connection with the embodiments disclosed herein are implemented as electronic hardware, computer software, or combinations of both. The various illustrative program modules and steps have been described generally in terms of their functionality. Whether the functionality is implemented as hardware or software depends in part upon the hardware constraints imposed on the system. Hardware and software may be interchangeable depending on such constraints. As examples, the various illustrative program modules and steps described in connection with the embodiments disclosed herein may be implemented or performed with an application specific integrated circuit (ASIC), a field programmable gate array (FPGA) or other programmable logic device, discrete gate or transistor logic, discrete hardware components, a conventional programmable software module and a processor, or any combination thereof designed to perform the functions described herein. The processor may be a microprocessor, CPU, controller, microcontroller, programmable logic device, array of logic elements, or state machine. The software module may reside in RAM memory, flash memory, ROM memory, EPROM memory, EEPROM memory, hard disk, a removable disk, a CD, DVD or any other form of storage medium known in the art. An exemplary processor may be coupled to the storage medium so as to read information from, and write information to, the storage medium. In the alternative, the storage medium may be integral to the processor.

In further embodiments, those skilled in the art will appreciate that the foregoing methods can be implemented by the execution of a program embodied on a computer readable medium. The medium may comprise, for example, RAM accessible by, or residing within the device. Whether contained in RAM, a diskette, 1 or other secondary storage media, the program modules may be stored on a variety of machine-readable data storage media, such as a conventional “hard drive”, magnetic tape, electronic read-only memory (e.g., ROM or EEPROM), flash memory, an optical storage device (e.g., CD, DVD, digital optical tape), or other suitable data storage media.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and any appended claims. It is indeed intended that the scope of the invention should be determined by proper interpretation and construction of any appended claims and their legal equivalents, as understood by those of skill in the art relying upon the disclosure in this specification and the attached drawings.

We claim:

1. A system for processing ideas of opportunities for improvement comprising:
a network receiving an opportunity for improvement idea and related data of the identification and a description of the opportunity for improvement idea from the idea originator;
the system receives a group generated hierarchy comprising:
organizational person designations;
departments;
work groups;
leaders of departments;
and users;
the system defines an idea notification group comprising the idea originator and all responsible parties based on the hierarchy;
the system receives an indication of a responsible party based on the hierarchy and the idea notification group is sent a notification;
the system receives acceptance of responsibility for the opportunity for improvement idea and the system updates the idea notification group with a notification;
the system ends the opportunity for improvement idea upon receiving completion or deletion of the opportunity for improvement idea and the idea notification group is sent notification of completion or deletion.

2. The system in claim 1 wherein the organizational hierarchy has persons in multiple departments.

3. The system in claim 1 wherein the organizational hierarchy is manipulated by the idea originator.

4. The system in claim 1 wherein the organizational hierarchy is updated to reflect organizational changes to personnel.

5. The system in claim 1 wherein the responsible party is chosen by the idea originator.

6. The system in claim 1 wherein the responsible party is chosen by business rules.

7. The system in claim 1 wherein the responsible party is more than 1 person.

8. The system in claim 1 wherein the responsible party can accept, delete, or assign the opportunity for improvement idea.

9. The system in claim 8 wherein the network receives assignment from the responsible party to route the opportunity for improvement idea to a new responsible party.

10. The system in claim 8 wherein the new responsible party is selected by the system from the hierarchy as the default responsible party.

11. The system in claim 8 wherein the new responsible party is selected by the previous responsible party.

12. The system in claim 1 wherein the network receives sends the opportunity for improvement idea to an alternative responsible party after a predetermined amount of time has elapsed and there has been no action by the responsible party and the idea notification group is sent notification of the new alternative responsible party.

13. The system in claim 1 wherein the completion of the opportunity of improvement idea generates a report containing identification of the idea originator, the facilitators of the idea, and estimations on financial impact of execution of the opportunity of improvement idea.

14. A system for processing ideas of opportunities for improvement comprising:
a network receiving an opportunity for improvement idea and related data of the description of the opportunity for improvement idea and the identification of the opportunity for improvement idea originator;
the system receives a user generated group hierarchy description;
the system defines an idea notification group comprising the idea originator and responsible parties based on the hierarchy description;
the system receives an indication of a responsible party;
the system sends notification of the opportunity for improvement idea to the idea notification group;
the system receives an acceptance from a member of the responsible party for the opportunity for improvement idea and the system sends notification to the idea notification group;
the system receives a checklist comprising individual tasks created by the acceptance member of the responsible party wherein the tasks are created, allocated and assigned to individual secondary responsible parties and the system sends notification to the idea notification group and the secondary responsible parties;
the system receives acceptance from secondary responsible party members for each individual task and sends notification to the idea notification group;
the system receives completion from the secondary responsible party members for each individual task and sends notification to the idea notification group;
the system ends the opportunity for improvement idea upon receiving a completion or deletion of the opportunity for improvement idea and notifies the idea notification group.

15. The system in claim 14 wherein the responsible party is chosen by the idea originator.

16. The system in claim 14. wherein the responsible party is more than one person.

17. The system in claim 14 wherein the responsible party is selected by business rules.

18. The system in claim 14 wherein one member of the responsible party can accept or assign the opportunity for improvement idea to a new responsible party.

19. The system in claim 14 wherein the idea notification group is selected by the idea originator.

20. The system in claim 14 wherein the acceptance from secondary responsible party member for each individual task notification is sent to the acceptance member of the responsible party.

21. The system in claim 14 wherein the completion from secondary responsible party member for each individual task notification is sent to the acceptance member of the responsible party.

22. A system for processing ideas of opportunities for improvement comprising:
a network receives a group challenge from a challenge creator comprising:
a description of the challenge to create more opportunity for improvement ideas;
an incentive for creating opportunities for improvement ideas;
a designated group from the organizational hierarchy for receiving the group challenge;
sends notification to the designated group;
sends award to members of the group designated by the challenge creator;
a network receiving an opportunity for improvement idea and related data of the identification and a description of the opportunity for improvement idea from the originator;
the system receives a group generated hierarchy;
the system defines an idea notification group comprising the idea originator and all responsible parties based on the hierarchy;
the system receives an indication of a responsible party based on the hierarchy and the idea notification group is sent a notification;
the system receives acceptance of responsibility for the opportunity for improvement idea and the system updates the idea notification group with a notification;
the system ends the opportunity for improvement idea upon receiving completion or deletion of the opportunity for improvement idea and the idea notification group is sent notification of completion or deletion.

23. The system in claim 12 wherein the network sends the award to the idea originator upon receiving completion.

24. A method for generating performance information on opportunities for improvement ideas, the method comprising:
a quality for improvement idea server;
a calendaring module for incorporating progress of opportunity for improvement ideas and implementation results;
a network receiving opportunity for improvement ideas from an idea originators;
the opportunity for improvement ideas sent to responsible parties based on an organization developed hierarchy;
a responsible party completing and implementing each of the opportunity for improvement ideas;
the system receives completion report for each opportunity for improvement idea;
the system receives financial and time transformations based on the implementation of each opportunity for improvement idea;
the system reports financial impact of implementation of opportunity for improvement ideas for the organization and for each department of the hierarchy and adjusts results with calendaring module for impact with respect to timelines.

25. The system in claim 24 wherein the financial impact of implementation includes results generated for challenge sequences.
